(19) United States
(12) Patent Application Publication
(10) Pub. No.: US 2016/0316311 A1
(43) Pub. Date: Oct. 27, 2016

(54) METHOD AND APPARATUS FOR PROVISIONING AN OPERATIONAL SUBSCRIPTION

(71) Applicant: Nokia Technologies Oy, Espoo (FI)

(72) Inventors: Silke Holtmanns, Klaukkala (FI); Alireza Sohi, Alleroed (DK)

(21) Appl. No.: 15/103,996

(22) PCT Filed: Dec. 13, 2013
(86) PCT No.: PCT/CN2013/089363

§ 371 Date: Jun. 13, 2016

(51) Int. Cl. H04W 4/00; H04W 60/04; H04M 1/725; H04W 8/20

(52) U.S. Cl. CPC H04W 4/001; H04W 8/20; H04W 60/04; H04M 1/72525

(57) ABSTRACT

Embodiments of the present invention provide a method and apparatus for provisioning an operational subscription. The method for provisioning an operational subscription comprising: establishing a connection from a first terminal to a provisioning server using the information of a first provisional subscription of the first terminal; transmitting a first terminal identifier of the first terminal to the provisioning server via the connection; and upon receipt of a message from the provisioning server, which was sent if, based on the first terminal identifier, the first terminal is already registered and one operational subscription of the first terminal is active, downloading from the provisioning server another operational subscription corresponding to the first provisional subscription. With the proposed solutions, it is more convenient for a user of the terminal to obtain operational subscriptions.

### FIELD OF THE INVENTION

Exemplary embodiments of the present invention relate generally to the mobile communication and, more specifically, to a method and apparatus for provisioning an operational subscription.

### BACKGROUND OF THE INVENTION

An embedded Universal Integrated Circuit Card (eUICC) is becoming more and more popular in recent years to provide users' devices and machines with operational subscriptions over the air or in general remotely. The eUICC, which may be a chip, a card or a software module equipped within a terminal, may contain different provisional subscriptions that allow initial connections to corresponding provisioning servers (for example, different operators). The eUICC may be implemented on a removable or an embedded form factor, like a System on a Chip (SoC) system. The provisioning servers then can provide respective operational subscriptions to the terminal by which a user of the terminal may enjoy services provided by, for example, the provisioning servers, such as voice communication, instant message service, data transfer, Internet browsing and the like. eUICCs are used and can be used in laptops, cars, ships, traffic lights, cameras and any kind of machine that needs cellular connectivity. Some of those machines are consumer devices which may also provide communication services that may fall under the local legislation with respect to lawful interception requirements.

In some countries a user must register his identity in person before obtaining a cellular subscription for his/her terminals because the government agencies would like to lawfully intercept into the communication of the user of that subscription when needed. In particular, the agencies might be interested if the subscription is used for location information transfer and for personal communication. In this case, if a user has several terminals or wants to obtain several different operational subscriptions from corresponding operational servers, the user has to bring every terminal to register at a shop of a preferred operator each time the user wants to obtain an operational subscription.

### SUMMARY OF THE INVENTION

Various embodiments of the invention aim at addressing at least part of the above problems and disadvantages. Other features and advantages of embodiments of the invention will also be understood from the following description of specific embodiments when read in conjunction with the accompanying drawings, which illustrate, by way of example, the principles of embodiments of the invention.

Various aspects of embodiments of the invention are set forth in the appended claims and summarized in this section. It shall be noted that the protection scope of the invention is only limited by the appended claims.

According to a first aspect, embodiments of the present invention provide a method, which comprises: establishing a connection from a first terminal to a provisioning server using the information of a first provisional subscription of the first terminal; transmitting a first terminal identifier of the first terminal to the provisioning server via the connection; and upon receipt of a message from the provisioning server, which was sent if, based on the first terminal identifier, the first terminal is already registered and one operational subscription of the first terminal is active, downloading from the provisioning server another operational subscription corresponding to the first provisional subscription. It is assumed that there is at least one terminal identifier for the first terminal, and potential identifiers are IMEI, terminal certificates, eUICC chip identity etc., as well as government issued identities.

In an exemplary embodiment, the method further comprises: if the first terminal is not registered or no operational subscription of the first terminal is active, receiving a registration notification from the provisioning server, wherein the registration notification informs a user of the first terminal to complete registration of the first terminal.

In an exemplary embodiment, the method further comprises: after the first terminal is registered, receiving a government issued identity corresponding to the user of the first terminal; and storing the government issued identity. The terminal may compromise then a multitude of different identities.

In an exemplary embodiment, the method further comprises: if the first terminal is not registered or no operational subscription of the first terminal is active, binding the first terminal with a second terminal that is already registered; receiving a second terminal identifier of the second terminal based on the binding and transmitting the second terminal identifier to the provisioning server via the connection; and if the second terminal responds to a query received from the provisioning server by acknowledging that the first terminal is bound with the second terminal, downloading from the provisioning server the other operational subscription corresponding to the first provisional subscription, wherein the query was sent if, based on the first and second terminal identifiers, the first terminal is not registered and the second terminal is already registered.

In an exemplary embodiment, wherein at least the first terminal is equipped with an eUICC.

According to a second aspect, embodiments of the present invention provide a method, which comprises: establishing a connection with a first terminal based on the information of a first provisional subscription of the first terminal; receiving a first terminal identifier of the first terminal via the connection; in response to determining that the first terminal is already registered and one operational subscription of the first terminal is active based on the first terminal identifier, generating another operational subscription corresponding to the first provisional subscription and transmitting a message to the first terminal, informing the first terminal to download the other operational subscription; and provisioning the other operational subscription to the first terminal.

In an exemplary embodiment, the method further comprises: if the first terminal is not registered or no operational subscription of the first terminal is active, transmitting a registration notification to the first terminal, wherein the registration notification informs a user of the first terminal to complete registration of the first terminal.

In an exemplary embodiment, the method further comprises: if the first terminal is not registered or no operational subscription of the first terminal is active, receiving from the first terminal a second terminal identifier of a second terminal via the connection; in response to determining that the first terminal is not registered and the second terminal is already registered based on the first and second terminal identifiers, transmitting a query to the second terminal; and if the second terminal responds to the query by acknowledging that the first terminal is bound with the second terminal, provisioning for the first terminal the other operational subscription corresponding to the first provisional subscription.

In an exemplary embodiment, wherein transmitting the query to the second terminal includes transmitting the query to the second terminal via a secure communication channel.

In an exemplary embodiment, the method further comprises: providing an identifier of the other operational subscription of the first terminal to a government backend. This may go directly or via some existing servers and interfaces.

In an exemplary embodiment, the method further comprises: checking a backlist that contains at least terminal identifiers of stolen terminals with the first terminal identifier and/or the second terminal identifier; and if the first terminal identifier or the second terminal identifier is within the backlist, preventing the other operational subscription corresponding to the first provisional subscription from being provisioned.

In an exemplary embodiment, wherein at least the first terminal is equipped with an eUICC.

According to a third aspect, embodiments of the present invention provide an apparatus, which comprises: a connection establishment module configured to establish a connection from a first terminal to a provisioning server using the information of a first provisional subscription of the first terminal; a first transmission module configured to transmit a first terminal identifier of the first terminal to the provisioning server via the connection; and a first downloading secure environment configured to, upon receipt of a message from the provisioning server, which was sent if, based on the first terminal identifier, the first terminal is already registered and one operational subscription of the first terminal is active, download from the provisioning server another operational subscription corresponding to the first provisional subscription.

In an exemplary embodiment, the apparatus further comprises a notification reception module configured to receive a registration notification from the provisioning server if the first terminal is not registered or no operational subscription of the first terminal is active, wherein the registration notification informs a user of the first terminal to complete registration of the first terminal.

In an exemplary embodiment, the apparatus further comprises an identity reception module configured to receive a government issued identity corresponding to the user of the first terminal after the first terminal is registered; and a storage environment configured to store the government issued identity.

In an exemplary embodiment, the apparatus further comprises a binding module configured to bind the first terminal with a second terminal that is already registered if the first terminal is not registered or no operational subscription of the first terminal is active; an identifier reception module configured to receive a second terminal identifier of the second terminal based on the binding; a second transmission module configured to transmit the second terminal identifier to the provisioning server via the connection; and a second downloading secure environment configured to download from the provisioning server the other operational subscription corresponding to the first provisional subscription if the second terminal responds to a query received from the provisioning server by acknowledging that the first terminal is bound with the second terminal, wherein the query was sent if, based on the first and second terminal identifiers, the first terminal is not registered and the second terminal is already registered.

In an exemplary embodiment, wherein at least the first terminal is equipped with an eUICC. In another exemplary embodiment, wherein the second terminals is equipped with a conventional UICC. In yet another exemplary embodiment, wherein the first terminal and the second terminal each are equipped with a respective eUICC.

According to a fourth aspect, embodiments of the present invention provide an apparatus, which comprises a first connection establishment module configured to establish a connection with a first terminal based on the information of a first provisional subscription of the first terminal; a first identifier reception module configured to receive a first terminal identifier of the first terminal via the connection; a generation module configured to generate another operational subscription corresponding to the first provisional subscription in response to determining that the first terminal is already registered and one operational subscription of the first terminal is active based on the first terminal identifier; a message transmission module configured to transmit a message to the first terminal, informing the first terminal to download the other operational subscription; and a first provision module configured to provision the other operational subscription to the first terminal.

In an exemplary embodiment, the apparatus further comprises a notification transmission module configured to transmit a registration notification to the first terminal if the first terminal is registered or no operational subscription of the first terminal is active, wherein the registration notification informs a user of the first terminal to complete registration of the first terminal.

In an exemplary embodiment, the apparatus further comprises: a second identifier reception module configured to receive from the first terminal a second terminal of the second terminal via the connection if the first terminal is not registered or no operational subscription of the first terminal is active; a query transmission module configured to transmit a query to the second terminal in response to determining that the first terminal is not registered and the second terminal is already registered based on the first and second terminal identifiers; and a second provision module configured to provision for the first terminal the other operational subscription corresponding to the first provisional subscription if the second terminal responds to the query by acknowledging that the first terminal is bound with the second terminal.

In an exemplary embodiment, wherein the query transmission module further configured to transmit the query to the second terminal via a secure communication channel.

In an exemplary embodiment, the apparatus further comprises a second providing environment configured to provide an identifier of the other operational subscription of the first terminal to a government backend.

In an exemplary embodiment, the apparatus further comprises: a check module configured to check a backlist that contains at least terminal identifiers of stolen terminals with the first terminal identifier and/or the second terminal identifier; and a prevention module configured to prevent the other operational subscription corresponding to the first provisional subscription from being provisioned if the first terminal identifier or the second terminal identifier is within the backlist.

In an exemplary embodiment, wherein at least the first terminal is equipped with an eUICC.

According to a fifth aspect, embodiments of the present invention provide an apparatus, which comprises: at least one processor; and at least one memory including computer program code, wherein the at least one memory and the computer program code are configured to, with the at least one processor, cause the apparatus at least to: establish, at a first terminal, a connection to a provisioning server using the information of a first provisional subscription of the first terminal; transmit a first terminal identifier of the first terminal to the provisioning server via the connection; and upon receipt of a message from the provisioning server, which was sent if, based on the first terminal identifier, the first terminal is already registered and one operational subscription of the first terminal is active, download from the provisioning server another operational subscription corresponding to the first provisional subscription.

According to a sixth aspect, embodiments of the present invention provide an apparatus, which comprises at least one processor; and at least one memory including computer program code, wherein the at least one memory and the computer program code are configured to, with the at least one processor, cause the apparatus at least to: establish a connection with a first terminal based on the information of a first provisional subscription of the first terminal; receive a first terminal identifier of the first terminal via the connection; in response to determining that the first terminal is already registered and one operational subscription of the first terminal is active based on the first terminal identifier, generate another operational subscription corresponding to the first provisional subscription and transmit a message to the first terminal, informing the first terminal to download the other operational subscription; and provision the other operational subscription to the first terminal.

According to a seventh aspect, embodiments of the present invention provide a computer-readable storage medium having computer program codes stored thereon, the computer program codes being configured to, when executed, cause an apparatus to perform the method according to the first aspect.

According to a eighth aspect, embodiments of the present invention provide a computer-readable storage medium having computer program codes stored thereon, the computer program codes being configured to, when executed, cause an apparatus to perform the method according to the second aspect.

These and other optional embodiments of the present invention can be implemented to realize one or more of the following advantages. In accordance with some embodiments of the present invention, by determining that a terminal is registered and one operational subscription of the terminal is active, the provisioning server can directly provision another operational subscription to the terminal so that it is convenient for the user of the terminal to download an operational subscription without bring the terminal to be registered each time. Moreover, by binding a registered terminal with other unregistered terminals, the unregistered terminals can download operational subscriptions without being registered at the shop, which may further improve the convenience of obtaining operational subscriptions for a user owing several terminals.

### BRIEF DESCRIPTION OF THE DRAWINGS

The above and other aspects, features, and benefits of various embodiments of the invention will become more fully apparent, by way of example, from the following detailed description and the accompanying drawings, in which like reference numerals refer to the same or similar elements:

FIG. 1 is a handshake diagram illustrating a process of provisioning an operational subscription according to an embodiment of the present invention;

FIG. 2 illustrates a flowchart of a method in the terminal of FIG. 1 according to an embodiment of the present invention;

FIG. 3 illustrates a flowchart of a method in the server of FIG. 1 according to an embodiment of the present invention;

FIG. 4 is a handshake diagram illustrating a process of provisioning an operational subscription according to another embodiment of the present invention;

FIG. 5 illustrates a flowchart of a method in the terminal of FIG. 4 according to an embodiment of the present invention;

FIG. 6 illustrates a flowchart of a method in the server of FIG. 4 according to an embodiment of the present invention;

FIG. 7 illustrates a block diagram of a terminal according to an embodiment of the present invention;

FIG. 8 illustrates a block diagram of an apparatus according to an embodiment of the present invention;

FIG. 9 illustrates a block diagram of an apparatus according to another embodiment of the present invention; and

FIG. 10 illustrates a block diagram of an apparatus according to another embodiment of the present invention.

### DETAILED DESCRIPTION OF EMBODIMENTS

Some preferred embodiments will be described in more detail with reference to the accompanying drawings, in which the preferred embodiments of the present disclosure have been illustrated. However, the present disclosure can be implemented in various manners, and thus should not be construed to be limited to the embodiments disclosed herein. On the contrary, those embodiments are provided for thorough and complete understanding of the present disclosure, and completely conveying the scope of the present disclosure to those skilled in the art.

In the following description, numerous specific details of embodiments of the present invention are set forth. However, it is understood that embodiments of the invention may be practiced without these specific details. In other instances, well-known circuits, structures and techniques have not been shown in detail in order not to obscure the understanding of this description. Those of ordinary skills in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. It shall be understood that the singular forms “a”, “an” and “the” include plural referents unless the context explicitly indicates otherwise.

Usually in many countries, there is more than one operator that provides subscription services to users, and one user would have to download an operational subscription from a provisioning server of the operator in order to enjoy the operator's subscription service. Moreover, as the developing of the Internet of things, a user may own several terminals that could all connect to the network and each run one or more operational subscriptions. In order to download operational subscriptions over the air, the terminals each are equipped with a respective eUICC.

Since users must register their terminal each time they want to obtain a new subscription as mentioned in the above, this may prove very challenging, if the eUICC in the terminal is physically embedded or if a user wants to download a subscription to his terminal before he is going to a trip to another country where he would be required to identify himself before the subscription can go active.

Therefore, although the eUICC allows users to download operational subscriptions remotely, it is still inconvenient for users to obtain operational subscriptions under the registration requirement, especially when their terminals are not easily portable, such as boats, ships, cars or the like or if the country where the user resides is not the same as the country the subscription is downloaded from.

In view of the foregoing, there is a need for convenient operational subscription provision such that users do not have to bring their terminals to the shop each time obtaining an operational subscription. The users should not be forced to identify themselves each time they request connectivity for one of their terminals. One identification should be enough.

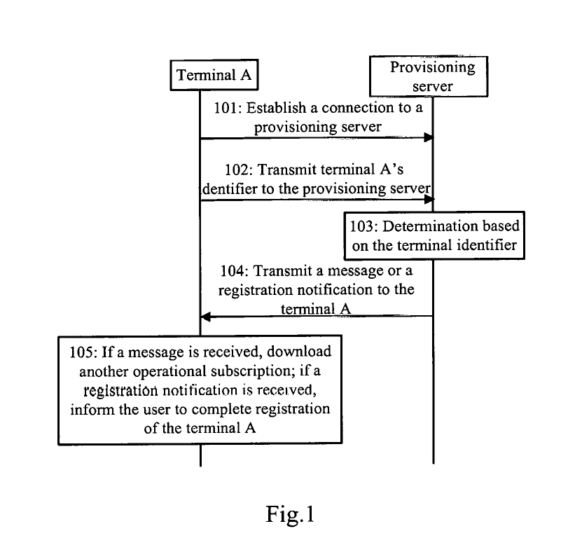

FIG. 1 is a handshake diagram illustrating a process of provisioning an operational subscription according to an embodiment of the present invention. In the embodiment of FIG. 1, the terminal A is equipped with an eUICC, which allows the terminal A to download an operational subscription over the air or in general remotely. The eUICC of terminal A contains different provisional subscriptions, by which the terminal A can connect to corresponding provisioning servers to download corresponding operational subscriptions.

At 101, a terminal A establishes a connection to a provisioning server using the information of a provisional subscription of the terminal A.

A provisional subscription is a network access application that may contain access credentials for connecting to a particular provisioning sever where a user of the terminal A desired an operational subscription to be downloaded. According to one embodiment of the present invention, the eUICC of the terminal A contains a plurality of provisional subscriptions; and the user may choose one of the provisional subscriptions that correspond to the desired provisioning server.

At 102, when a connection with the provisioning server is established, the terminal A transmits its terminal identifier IDₐ to the provisioning server via the connection.

The terminal identifier IDₐ may be a permanent terminal identifier by which the provisioning server can identify the terminal A. It is assumed that there is at least one terminal identifier for the first terminal. By way of example, the terminal identifier IDₐ may be an eUICC identity, an IMEI (International Mobile Equipment Identity), a terminal certificate, government provided identity or the combination thereof.

After the provisioning server receives the terminal identifier IDₐ at 102, the process proceeds to 103. At 103, the provisioning server determines whether the terminal A is registered and whether one operational subscription of the terminal A is active based on the terminal identifier IDₐ.

The provisioning server may perform the determination of whether the terminal A is registered directly or may transmit the terminal identifier IDₐ to a government backend and the determination is then performed by the government backed based on the terminal identifier IDₐ. According to one embodiment of the present invention, the provisioning itself or the government backend may contain a mapping list of registered terminals and terminal identifiers. By checking the mapping list, the provisioning server or the government backend may determine whether the terminal A is registered. When the determination is completed at the government backend, the result may then be transferred to the provisioning server.

For the determination of whether one operational subscription of the terminal A is active, the provisioning server may check a service profile, such as HLR (Home Location Register)/HSS (Home Subscriber Server), based on the terminal identifier IDₐ in an embodiment of the present invention. This service profile may contain the information about whether an operational subscription is active or not. The terminal A may already have several operational subscriptions or may have no operational subscription within it.

At 103, if the provisioning server determines that the terminal A is already registered and at least one operational subscription of the terminal A is active, it means that there is already at least one operational subscription working on the terminal A and the user of the terminal A has registered the terminal A to the government. As a result, when the user wants to download another operational subscription, the terminal A does not have to be registered again and the desired operational subscription can be provisioned to the terminal A directly. Note that the terminal A may have more than one active operational subscription, and the provisioning server may only need to determine that at least one of those operational subscriptions is active and working on the terminal A.

If the provisioning server determines that the terminal A is not registered or no operational subscription of the terminal A is active, it means that the user of the terminal A will have to register the terminal A to the government based on the local law requirement. In this case, the terminal A may be already registered but no operational subscription of the terminal A is active. This may happen if the terminal A has been bought from somebody else and its previous owner has not deregistered it, or if the pre-paid operational subscriptions are all expired, and the terminal A is required to be registered once again so as to clarify the one currently using this terminal. For the case that the pre-paid operational subscriptions are expired, according to one embodiment, the provisioning server may also provide a message to the terminal A, informing the user of the terminal A to pay for the operational subscriptions so as to activate the operational subscriptions.

Based on the result of the determination, the provisioning server transmits a message or a registration notification to the terminal A at 104. The message is sent when the provisioning server determines that the first terminal is already registered and one operational subscription of the first terminal is active based on the terminal identifier IDₐ. The registration notification is sent when the provisioning server determines that the terminal A is already registered and one operational subscription of the terminal A is active based on the terminal identifier IDₐ.

At 105, if a message is received from the provisioning server, the terminal A downloads from the provisioning server another operational subscription corresponding to the provisional subscription; if a registration notification is received from the provisioning server, the terminal A informs its user to complete registration.

The other operational subscription, which may be different from the operational subscriptions currently working on the terminal A, can be generated by the provisioning server before or immediately after the message is transmitted. According to an embodiment of the present invention, the provisioning server may create a new identifier of the other operational subscription by which the user of the terminal A can enjoy the service of this operational subscription. By way of example, the identifier of this operational subscription may be a MSISDN (Mobile Subscriber International ISDN/PSTN Number), an IMSI (International Mobile Subscriber Identification Number) or the like. According to a further embodiment, the provisioning server may provide the identifier of the other operational subscription of the terminal A to a government backend so that the government agencies may lawfully intercept into the operational subscription by the government backend based on this identifier. According to another embodiment, a record is created in the government backend and/or in the provisioning server, which contains the information about which users or terminals belongs to which subscriptions. So when a lawful interception is needed, the government agencies may intercept into the communication of the subscription of a particular user.

In the case that a registration notification is received, the terminal A may output a warning for the user so as to instruct the user to register the terminal A. The user may complete the registration of the terminal A according to the local legislation, for example, by showing electronic government ID or credit card, using a post-identity system, face to face registration or the like.

When completing the registration, the terminal A may back to download the desired operational subscription by continuing performing the process shown in FIG. 1.

According to a further embodiment of the present invention, after the terminal A is registered, the terminal A may receive a government issued identity corresponding to the user of the first terminal, and store the government issued identity for the government's further check. The government issued identity is convenient for the government backend to check if the terminal A is registered or not. According to another embodiment, the government backend may also create a record for the registered terminal, which contains the mapping relationship of terminals and their government issued identities and/or terminal identifiers.

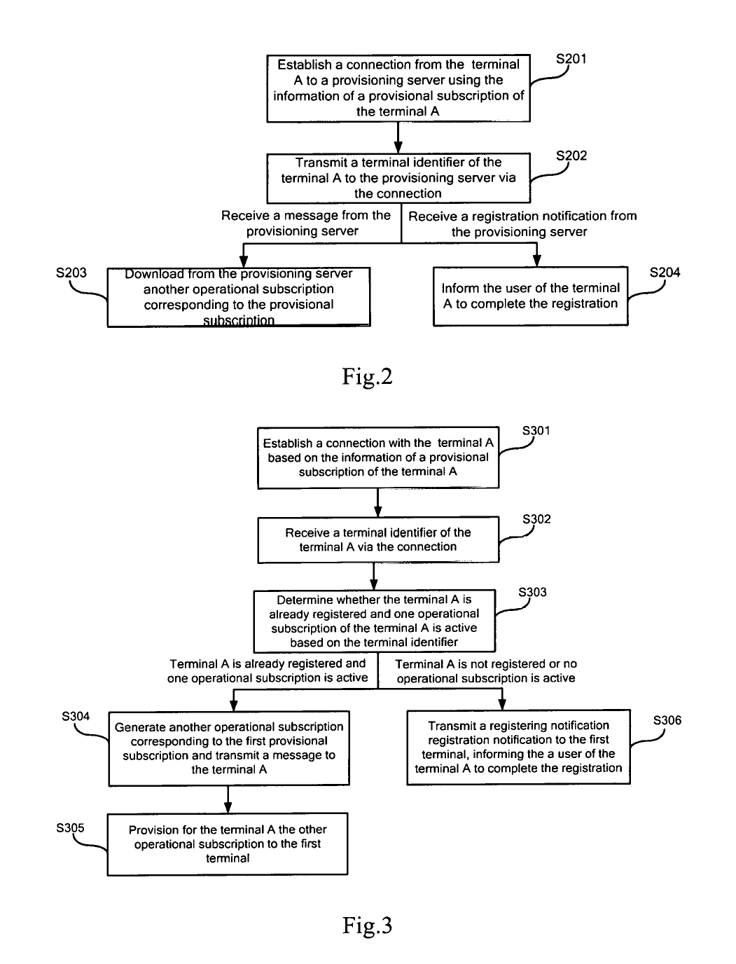

FIG. 2 and FIG. 3 illustrate the methods performed by the terminal A and the provisioning server respectively in the process illustrated in FIG. 1.

In the discussion above, the user of terminal A can download another operational subscription from the provisional server without bring the terminal A to the shop for registration if the terminal A is previously registered and one operational subscription of the terminal A is active, which is more convenient for the user to download several different operational subscriptions.

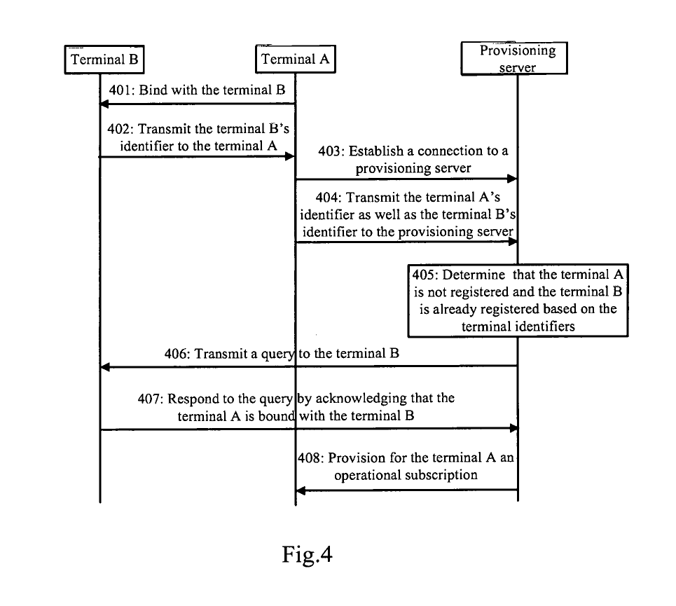

FIG. 4 is a handshake diagram illustrating a process of provisioning an operational subscription according to another embodiment of the present invention. In this embodiment, when a user has more than one terminal (for example, a terminal A and a terminal B), on the basis that one terminal is already registered (for example, the terminal B is already registered), the other terminals are not required to be brought to the shop for registration when downloading an operational subscription.

Example is continued taken under a terminal A, which is not registered yet, or had been registered before but the previous operational subscriptions are not active and can not download the operational subscription from the server directly. A terminal B, which is another terminal of the user of the terminal A, has already been registered and now will help the terminal A to download the operational subscription. In this example, the terminal A is equipped with an eUICC. The terminal B is not necessary to be equipped with an eUICC, instead, it may be equipped a conventional UICC, such as a SIM card. The one which matters is that the terminal B is already registered. In an embodiment, the terminal B may have one or more working operational subscriptions within it.

Note that the process illustrated in FIG. 4 may be executed as a continued part of the process illustrated in FIG. 1 when the provisioning server determines that the terminal A is not registered or no operational subscription of the terminal A is active; or the process of FIG. 4 may be executed as the very beginning when the terminal A is sure to be unregistered or no operational subscription of the terminal A is active.

At 401, the terminal A binds with the terminal B. The way of binding depends on the terminal capacity. According to an embodiment, the binding method comprises, but not limited to, Bluetooth connection, PIN pairing, NFE touching, challenge response, PIN via SMS, or the like.

At 402, the terminal B transmits its terminal identifier ID_{b} to the terminal A based on the binding. In anther embodiment, the terminal A may store the terminal identifier ID_{b} such that the terminal B does not have to transmit its terminal identifier every time performing the process.

At 403, the terminal A establishes a connection to the provisioning server based on the information of a provisional subscription of the terminal A. This establishment of connection may be the processed as discussed at 101 of FIG. 1, the terminal B is also equipped with an eUICC that contains different provisional subscriptions, allowing the terminal B to connect to corresponding provisioning servers.

Note that 403 may be performed after 401 and 402 as illustrated in FIG. 4, and 403 may also be performed before 401 and 402.

After the terminal identifier ID_{b} of the terminal B is received and a connection to the provisioning server is established, at 404, the terminal A transmits the terminal identifiers of both the terminals A and B to the provisioning server via the connection. In one embodiment, the terminal identifier IDₐ may be transmitted to the provisioning server firstly once the connection of the terminal A and the provisioning server is established, and the terminal identifier ID_{b} may be transmitted after the terminal A has received it from the terminal B.

According to one embodiment, if the process of FIG. 4 is a continued part of the process of FIG. 1 when the provisioning server determines that the terminal A is not registered or no operational subscription of the terminal A is active, then the connection establishment step 403 may be omitted, and at 404, the terminal identifier of the terminal A may not be transmitted to the provisioning server since the server has previously received the terminal A's identifier.

At 405, the provisioning server determines whether the terminals A and B are registered based on their terminal identifiers respectively. As mentioned above, the provisioning server determines that the terminal A is not registered while the terminal B is already registered.

At 406, the provisioning server transmits a query to the terminal B, querying that whether the terminal A is bound with the terminal B. According to an embodiment, the query may contain the terminal identifier IDₐ of the terminal A such that the terminal B may identify the terminal A.

According to a further embodiment of the present invention, the query may be transmitted to the terminal B via a secure communication channel so as to improve the security of the query.

At 407, the terminal B responds to the query by acknowledging that the terminal A is bound with the terminal B based on the terminal identifier IDₐ. In one embodiment of the present invention, the terminal B responds to the query by requesting the user to insert a token, such as his/her usual SIM PIN to confirm the binding.

At 408, the provisioning server provisions for the terminal A an operational subscription corresponding to the provisional subscription of the terminal A. In an example, the provisioning server generates the operational subscription of the terminal A and transmits a message to the terminal A, informing the terminal A to download the operational subscription. When the message is received, the terminal A starts to download this operational subscription from the provisioning server.

In this case, because the terminal A and the terminal B are securely binding together, it is sure that these terminals belong to the same user who has been registered to the government, so the provisioning server can directly provision the operational subscription wanted by the unregistered terminal A without requiring the terminal A to be registered.

By binding a registered terminal with other unregistered terminals, the unregistered terminals can download operational subscriptions without being registered at the shop, which may further improve the convenience of obtaining operational subscriptions for a user owing several terminals.

According to another embodiment of the present invention, after provisioning the operational subscription to the terminal A, the provisioning server may also provide an identifier of this operational subscription to the government backend for subsequent lawful interception.

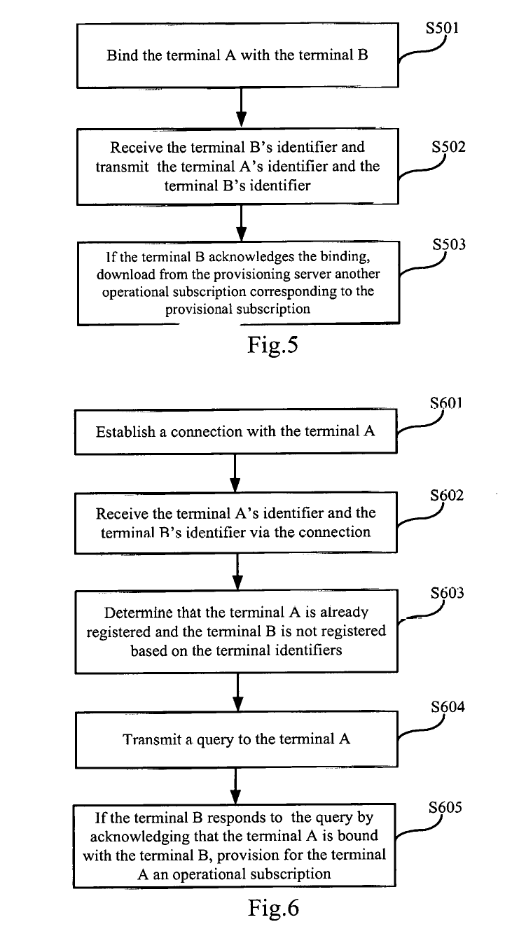

FIG. 5 and FIG. 6 illustrate the methods performed by the terminal A and the provisioning server respectively in the process illustrated in FIG. 4.

In a further embodiment, in the processes of FIG. 1 and FIG. 4, when the provisioning determine whether the terminal A and/or the terminal B are registered, the provisioning further check a backlist that contains at least terminal identifiers of stolen terminals with the terminal identifiers of the terminals A and/or B, and if the terminal A or the terminal B is within the backlist, which means that the terminal A or the terminal B may be stolen, the provisioning server may prevent the operational subscription as requested by the terminal A from being provisioned in order to keep the security of the user. In one embodiment, the backlist is stored within the provisioning server. In other embodiments, the backlist may be external to the provisioning server, and may be maintained by the government backend.

By this way, when a terminal is stolen, the user can report to the provisioning server or the government backend so that the stolen terminal can be added into the backlist, which will prevent the terminal from being used by the “naughty”. Moreover, the user may also disable the subscription of the terminal or deregister the terminal when the terminal is stolen.

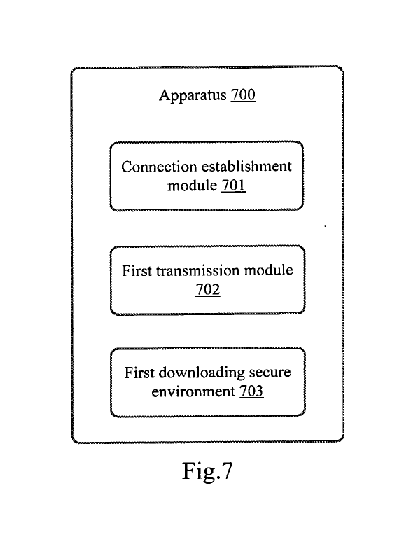

Reference is now made to FIG. 7, which illustrates a block diagram of an apparatus 700 according to an embodiment of the present invention. The apparatus 700 according to FIG. 7 may perform the methods of FIGS. 2 and 5 but is not limited to these methods. The methods of FIGS. 2 and 5 may be performed by the apparatus of FIG. 7 but is not limited to being performed by this apparatus 700. The apparatus 700 may be a terminal or a part of the terminal.

The apparatus 700 comprises a connection establishment module 701, a first transmission module 702, and a first downloading secure environment 703. The connection establishment module 701 is configured to establish a connection from a first terminal to a provisioning server using the information of a first provisional subscription of the first terminal. The first transmission module 702 is configured to transmit a first terminal identifier of the first terminal to the provisioning server via the connection. The first downloading secure environment 701 is configured to, upon receipt of a message from the provisioning server, which was sent if, based on the first terminal identifier, the first terminal is already registered and one operational subscription of the first terminal is active, download from the provisioning server another operational subscription corresponding to the first provisional subscription.

The apparatus 700 further comprises a notification reception module configured to receive a registration notification from the provisioning server if the first terminal is not registered or no operational subscription of the first terminal is active, wherein the registration notification informs a user of the first terminal to complete registration of the first terminal.

The apparatus 700 further comprises an identity reception module and a storage environment. The identity reception module is configured to receive a government issued identity corresponding to the user of the first terminal after the first terminal is registered; and the storage environment is configured to store the government issued identity.

The apparatus 700 further comprises a binding module, an identifier reception module, a second transmission module, and a second downloading secure environment. The binding module is configured to bind the first terminal with a second terminal that is already registered if the first terminal is not registered or no operational subscription of the first terminal is active; an identifier reception module configured to receive a second terminal identifier of the second terminal based on the binding; a second transmission module configured to transmit the second terminal identifier to the provisioning server via the connection; and a second downloading secure environment configured to download from the provisioning server the other operational subscription corresponding to the first provisional subscription if the second terminal responds to a query received from the provisioning server by acknowledging that the first terminal is bound with the second terminal, wherein the query was sent if, based on the first and second terminal identifiers, the first terminal is not registered and the second terminal is already registered.

According to an embodiment of the present invention, wherein at least the first terminal is equipped with an eUICC.

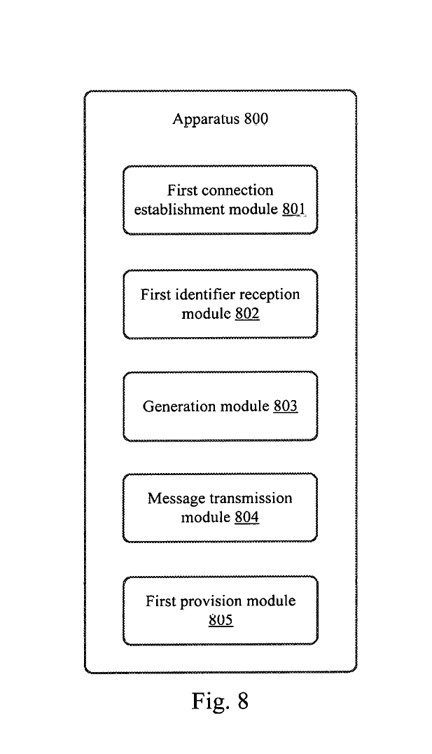

Reference is now made to FIG. 8, which illustrates a block diagram of an apparatus 800 according to an embodiment of the present invention. The apparatus 800 according to FIG. 8 may perform the methods of FIGS. 3 and 6 but is not limited to these methods. The methods of FIGS. 4 and 6 may be performed by the apparatus of FIG. 8 but is not limited to being performed by this apparatus 800.

The apparatus 800 comprises a first connection establishment module 801, a first identifier reception module 802, a generation module 803, a message transmission module 804 and a first provision module 805. The first connection establishment module 801 is configured to establish a connection with a first terminal based on the information of a first provisional subscription of the first terminal; the first identifier reception module 802 is configured to receive a first terminal identifier of the first terminal via the connection; the generation module 803 is configured to generate another operational subscription corresponding to the first provisional subscription in response to determining that the first terminal is already registered and one operational subscription of the first terminal is active based on the first terminal identifier; the message transmission module 804 is configured to transmit a message to the first terminal, informing the first terminal to download the other operational subscription; and the first provision module 805 is configured to provision the other operational subscription to the first terminal.

The apparatus 800 further comprises a notification transmission module. The notification transmission module is configured to transmit a registration notification to the first terminal if the first terminal is not registered or no operational subscription of the first terminal is active, wherein the registration notification informs a user of the first terminal to complete registration of the first terminal.

The apparatus 800 further comprises a second identifier reception module, a query transmission module and a second provision module. The second identifier reception module is configured to receive from the first terminal a second terminal of the second terminal via the connection if the first terminal is not registered or no operational subscription of the first terminal is active; the query transmission module is configured to transmit a query to the second terminal in response to determining that the first terminal is not registered and the second terminal is already registered based on the first and second terminal identifiers; and the second provision module is configured to provision for the first terminal the other operational subscription corresponding to the first provisional subscription if the second terminal responding to the query by acknowledging that the first terminal is bound with the second terminal.

According to an embodiment of the present invention, wherein the query transmission module further configured to transmit the query to the second terminal via a secure communication channel.

The apparatus 800 further comprises a providing environment. The providing environment configured to provide an identifier of the other operational subscription of the first terminal to a government backend.

The apparatus 800 further comprises a check module and a prevention module. The check module is configured to check a backlist that contains at least terminal identifiers of stolen terminals with the first terminal identifier and/or the second terminal identifier; and the prevention module configured to prevent the other operational subscription corresponding to the first provisional subscription from being provisioned if the first terminal identifier or the second terminal identifier is within the backlist.

According to an embodiment of the present invention, wherein at least the first terminal is equipped with an eUICC.

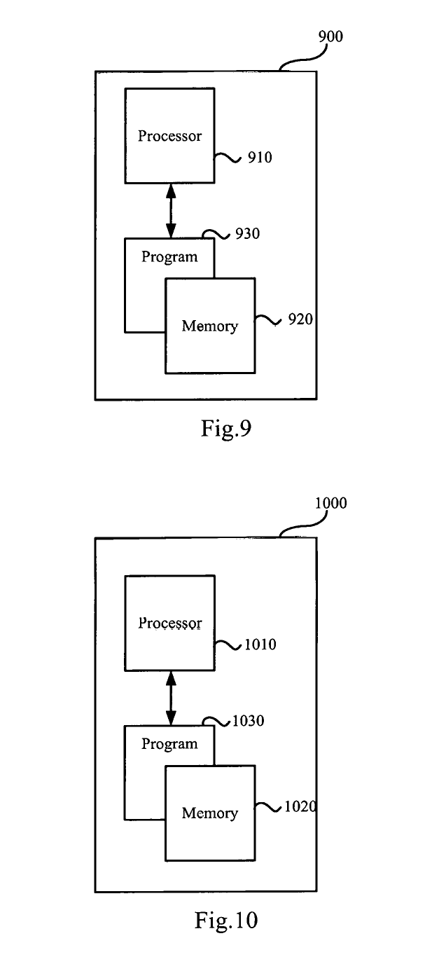

Reference is now made to FIG. 9, which illustrates a block diagram of an apparatus 900 according to another embodiment of the present invention. The apparatus 900 may be implemented in or as a part of, for example, a cell phone, a boat, a car, or any other suitable terminal in a wired or wireless commutation system such as a LTE system.

As shown in FIG. 9, the apparatus 900 may comprises at least one processor 910 and at least one memory 920 including computer program codes 930, wherein the at least one memory 920 and the computer program codes 930 are configured to, with the at least one processor 910, cause the apparatus 900 at least to: establish, at a first terminal, a connection to a provisioning server using the information of a first provisional subscription of the first terminal; transmit a first terminal identifier of the first terminal to the provisioning server via the connection; and upon receipt of a message from the provisioning server, which was sent if, based on the first terminal identifier, the first terminal is already registered and one operational subscription of the first terminal is active, download from the provisioning server another operational subscription corresponding to the first provisional subscription.

Reference is now made to FIG. 10, which illustrates a block diagram of an apparatus 1000 according to another embodiment of the present invention. The apparatus 1000 may be implemented in or as a part of, for example, a server.

As shown in FIG. 10, the apparatus 1000 may comprises at least one processor 1010 and at least one memory 1020 including computer program codes 1030, wherein the at least one memory 1020 and the computer program codes 1030 are configured to, with the at least one processor 1010, cause the apparatus 1000 at least to: establish a connection with a first terminal based on the information of a first provisional subscription of the first terminal; receive a first terminal identifier of the first terminal via the connection; in response to determining that the first terminal is already registered and one operational subscription of the first terminal is active based on the first terminal identifier, generate another operational subscription corresponding to the first provisional subscription and transmit a message to the first terminal, informing the first terminal to download the other operational subscription; and provision the other operational subscription to the first terminal.

Embodiments of the present invention have also provided apparatuses comprising means for performing each step as illustrated in conjunction with FIGS. 1 to 6.

In a first aspect of the invention, it provides an apparatus, comprising: means for establishing a connection from a first terminal to a provisioning server using the information of a first provisional subscription of the first terminal; means for transmitting a first terminal identifier of the first terminal to the provisioning server via the connection; and means for downloading from the provisioning server another operational subscription corresponding to the first provisional subscription upon receipt of a message from the provisioning server, which was sent if, based on the first terminal identifier, the first terminal is already registered and one operational subscription of the first terminal is active.

In a second aspect of the invention, the apparatus according to the first aspect further comprises means for receiving a registration notification from the provisioning server if the first terminal is not registered or no operational subscription of the first terminal is active, wherein the registration notification informs a user of the first terminal to complete registration of the first terminal.

In a third aspect of the invention, the apparatus according to the second aspect further comprises: means for receiving a government issued identity corresponding to the user of the first terminal after the first terminal is registered; and means for storing the government issued identity.

In a fourth aspect of the invention, the apparatus according to the first aspect further comprises: means for binding the first terminal with a second terminal that is already registered if the first terminal is not registered or no operational subscription of the first terminal is active; means for receiving a second terminal identifier of the second terminal based on the binding; means for transmitting the second terminal identifier to the provisioning server via the connection; and means for downloading from the provisioning server the other operational subscription corresponding to the first provisional subscription if the second terminal responds to a query received from the provisioning server by acknowledging that the first terminal is bound with the second terminal, wherein the query was sent if, based on the first and second terminal identifiers, the first terminal is not registered and the second terminal is already registered.

In a fifth aspect of the invention, the apparatus according to any of the first to the fourth aspects, wherein at least the first terminal is equipped with an embedded universal integrated circuit card.

In a sixth aspect of the invention, it provides an apparatus, comprises: means for establishing a connection with a first terminal based on the information of a first provisional subscription of the first terminal; means for receiving a first terminal identifier of the first terminal via the connection; means for generating another operational subscription corresponding to the first provisional subscription in response to determining that the first terminal is already registered and one operational subscription of the first terminal is active based on the first terminal identifier; means for transmitting a message to the first terminal, informing the first terminal to download the other operational subscription; and means for provisioning the other operational subscription to the first terminal.

In a seventh aspect of the invention, the apparatus according to the sixth aspect further comprises: means for transmitting a registration notification to the first terminal if the first terminal is registered or no operational subscription of the first terminal is active, the registration notification informing a user of the first terminal to complete registration of the first terminal.

In a eighth aspect of the invention, the apparatus according to the sixth aspect further comprises: means for receiving from the first terminal a second terminal identifier of a second terminal via the connection if the first terminal is not registered or no operational subscription of the first terminal is active; means for transmitting a query to the second terminal in response to determining that the first terminal is not registered and the second terminal is already registered based on the first and second terminal identifiers; and means for provisioning for the first terminal the other operational subscription corresponding to the first provisional subscription if the second terminal responds to the query by acknowledging that the first terminal is bound with the second terminal.

In a ninth aspect of the invention, the apparatus according to the eighth aspect further comprises means for transmitting the query to the second terminal via a secure communication channel.

In a tenth aspect of the invention, the apparatus according to any of the sixth to the ninth aspects further comprises means for providing an identifier of the other operational subscription of the first terminal to a government backend.

In a eleventh aspect of the invention, the apparatus according to any of the sixth to the ninth aspects further comprises means for checking a backlist that contains at least terminal identifiers of stolen terminals with the first terminal identifier and/or the second terminal identifier; and means for preventing the other operational subscription corresponding to the first provisional subscription from being provisioned if the first terminal identifier or the second terminal identifier is within the backlist.

In a twelfth aspect of the invention, the apparatus according to any of the sixth to the ninth aspects, wherein at least the first terminal is equipped with an embedded universal integrated circuit card.

The present invention also provided a computer-readable storage medium having computer program codes stored thereon, the computer program codes being configured to, when executed, cause an apparatus to perform steps in the methods as described hereinabove. Further, there is provided a computer program product comprising a computer-readable storage medium as provided in the present invention.

The embodiments of the invention described hereinbefore in association with FIGS. 1 to 6 may be used in any combination with each other. Several of the embodiments may be combined together to form a further embodiment of the invention.

As used in this application, the term ‘circuitry’ and ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3G communications networks, 4G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware may be used to implement the exemplary embodiments, and they may be appreciated by those skilled in the hardware art(s). For example, the functionality of one or more of the components of the exemplary embodiments can be implemented via one or more hardware devices, or one or more software entities such as modules.

The exemplary embodiments can store information relating to various processes described herein. This information can be stored in one or more memories, such as a hard disk, optical disk, magneto-optical disk, RAM, and the like. One or more databases can store the information regarding cyclic prefixes used and the delay spreads measured. The databases can be organized using data structures (for example, records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of one or more application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a static RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

The embodiments of the invention described hereinbefore in association with the figures presented and the summary of the invention may be used in any combination with each other. Several of the embodiments may be combined together to form a further embodiment of the invention.

It is obvious to a person skilled in the art that with the advancement of technology, the basic idea of the invention may be implemented in various ways. The invention and its embodiments are thus not limited to the examples described above; instead they may vary within the scope of the claims.

1-38. (canceled)

39. A method, comprising:
establishing a connection from a first terminal to a provisioning server using the information of a first provisional subscription of the first terminal;
transmitting a first terminal identifier of the first terminal to the provisioning server via the connection; and
upon receipt of a message from the provisioning server, which was sent if, based on the first terminal identifier, the first terminal is already registered and one operational subscription of the first terminal is active, downloading from the provisioning server another operational subscription corresponding to the first provisional subscription.

40. The method according to claim 39 further comprising:
if the first terminal is not registered or no operational subscription of the first terminal is active, receiving a registration notification from the provisioning server, wherein the registration notification informs a user of the first terminal to complete registration of the first terminal.

41. The method according to claim 40 further comprising:
after the first terminal is registered, receiving a government issued identity corresponding to the user of the first terminal; and
storing the government issued identity.

42. The method according to claim 39 further comprising:
if the first terminal is not registered or no operational subscription of the first terminal is active, binding the first terminal with a second terminal that is already registered;
receiving a second terminal identifier of the second terminal based on the binding and transmitting the second terminal identifier to the provisioning server via the connection; and
if the second terminal responds to a query received from the provisioning server by acknowledging that the first terminal is bound with the second terminal, downloading from the provisioning server the other operational subscription corresponding to the first provisional subscription, wherein the query was sent if, based on the first and second terminal identifiers, the first terminal is not registered and the second terminal is already registered.

43. A method, comprising:
establishing a connection with a first terminal based on the information of a first provisional subscription of the first terminal;
receiving a first terminal identifier of the first terminal via the connection;
in response to determining that the first terminal is already registered and one operational subscription of the first terminal is active based on the first terminal identifier, generating another operational subscription corresponding to the first provisional subscription and transmitting a message to the first terminal, informing the first terminal to download the other operational subscription; and
provisioning the other operational subscription to the first terminal.

44. The method according to claim 43 further comprising:
if the first terminal is not registered or no operational subscription of the first terminal is active, transmitting a registration notification to the first terminal, wherein the registration notification informs a user of the first terminal to complete registration of the first terminal.

45. The method according to claim 43 further comprising:
if the first terminal is not registered or no operational subscription of the first terminal is active, receiving from the first terminal a second terminal identifier of a second terminal via the connection;
in response to determining that the first terminal is not registered and the second terminal is already registered based on the first and second terminal identifiers, transmitting a query to the second terminal; and
if the second terminal responds to the query by acknowledging that the first terminal is bound with the second terminal, provisioning for the first terminal the other operational subscription corresponding to the first provisional subscription.

46. The method according to claim 45 wherein transmitting the query to the second terminal includes transmitting the query to the second terminal via a secure communication channel.

47. The method according to claim 43 further comprising:
providing an identifier of the other operational subscription of the first terminal to a government backend.

48. The method according to claim 43 further comprising:
checking a blacklist that contains at least terminal identifiers of stolen terminals with the first terminal identifier and/or the second terminal identifier; and
if the first terminal identifier or the second terminal identifier is within the blacklist, preventing the other operational subscription corresponding to the first provisional subscription from being provisioned.

49. An apparatus, comprising:
at least one processor; and
at least one memory including computer program code,
wherein the at least one memory and the computer program code are configured to, with the at least one processor, cause the apparatus at least to:
establish, at a first terminal, a connection to a provisioning server using the information of a first provisional subscription of the first terminal;
transmit a first terminal identifier of the first terminal to the provisioning server via the connection; and
upon receipt of a message from the provisioning server, which was sent if, based on the first terminal identifier, the first terminal is already registered and one operational subscription of the first terminal is active, download from the provisioning server another operational subscription corresponding to the first provisional subscription.

50. The apparatus according to claim 49 wherein the at least one memory and the computer program code are further configured to, with the at least one processor, cause the apparatus to:
receive a registration notification from the provisioning server if the first terminal is not registered or no operational subscription of the first terminal is active, wherein the registration notification informs a user of the first terminal to complete registration of the first terminal.

51. The apparatus according to claim 50 wherein the at least one memory and the computer program code are further configured to, with the at least one processor, cause the apparatus to:
receive a government issued identity corresponding to the user of the first terminal after the first terminal is registered; and
store the government issued identity.

52. The apparatus according to claim 49 wherein the at least one memory and the computer program code are further configured to, with the at least one processor, cause the apparatus to:
bind the first terminal with a second terminal that is already registered if the first terminal is not registered or no operational subscription of the first terminal is active;
receive a second terminal identifier of the second terminal based on the binding and transmit the second terminal identifier to the provisioning server via the connection;
download from the provisioning server the other operational subscription corresponding to the first provisional subscription if the second terminal responding to a query received from the provisioning server by acknowledging that the first terminal is bound with the second terminal, wherein the query was sent if, based on the first and second terminal identifiers, the first terminal is not registered and the second terminal is already registered.

53. An apparatus, comprising:
at least one processor; and
at least one memory including computer program code,
wherein the at least one memory and the computer program code are configured to, with the at least one processor, cause the apparatus at least to:
establish a connection with a first terminal based on the information of a first provisional subscription of the first terminal;
receive a first terminal identifier of the first terminal via the connection;
in response to determining that the first terminal is already registered and one operational subscription of the first terminal is active based on the first terminal identifier, generate another operational subscription corresponding to the first provisional subscription and transmit a message to the first terminal, informing the first terminal to download the other operational subscription; and
provision the other operational subscription to the first terminal.

54. The apparatus according to claim 53 wherein the at least one memory and the computer program code are further configured to, with the at least one processor, cause the apparatus to:
transmit a registration notification to the first terminal if the first terminal is not registered or no operational subscription of the first terminal is active, wherein the registration notification informs a user of the first terminal to complete registration of the first terminal.

55. The apparatus according to claim 53 wherein the at least one memory and the computer program code are further configured to, with the at least one processor, cause the apparatus to:
receive from the first terminal a second terminal identifier of a second terminal via the connection if the first terminal is not registered or no operational subscription of the first terminal is active ;
in response to determining that the first terminal is not registered and the second terminal is already registered based on the first and second terminal identifiers, transmit a query to the second terminal; and
provision for the first terminal the other operational subscription corresponding to the first provisional subscription if the second terminal responds to the query by acknowledging that the first terminal is bound with the second terminal.

56. The apparatus according to claim 55 wherein transmitting the query to the second terminal includes transmitting the query to the second terminal via a secure communication channel.

57. The apparatus according to claim 53 wherein the at least one memory and the computer program code are further configured to, with the at least one processor, cause the apparatus to:
provide an identifier of the other operational subscription of the first terminal to the government backend.

58. The apparatus according to claim 53 wherein the at least one memory and the computer program code are further configured to, with the at least one processor, cause the apparatus to:
check a blacklist that contains at least terminal identifiers of stolen terminals with the first terminal identifier and/or the second terminal identifier;
prevent the other operational subscription corresponding to the first provisional subscription from being provisioned if the first terminal identifier or the second terminal identifier is within the blacklist.
